(19) United States
(12) Patent Application Publication
(10) Pub. No.: US 2008/0313002 A1
(43) Pub. Date: Dec. 18, 2008

(54) METHOD, SYSTEM, AND APPARATUS FOR OPERATING A REGISTRY

(75) Inventors: Paul McFarland, Paducah, KY (US); Stephen J. Shaw, Pittsburgh, PA (US); Christopher W. Umble, Gibsonia, PA (US); Lisa Langford, Allison Park, PA (US); Bruce Miller, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/137,899

(22) Filed: Jun. 12, 2008

Related U.S. Application Data
(60) Provisional application No. 60/944,567, filed on Jun. 18, 2007.

(51) Int. Cl. G06Q 10/00; G06Q 50/00; G06F 17/30

(52) U.S. Cl. 705/8; 705/10; 707/104.1; 707/E17.005

(57) ABSTRACT

Various embodiments of the present invention relate to a method for operating a registry of service providers in a given service sector, an apparatus for operating a registry of service providers in a given service sector, and a system for operating a registry of service providers in a given service sector. In one embodiment, a method of operating a registry of service providers in a given service sector comprises providing a plurality of service providers in the given sector with input access to an electronic database to which each participating service supplies information, and validating the supplied information.

### FIELD OF THE INVENTION

The present invention relates generally to a method, a system, and an apparatus for operating a registry of service providers and in particular to a method, a system, and an apparatus for operating a registry of automotive glass repair and replacement service providers.

### BACKGROUND OF THE INVENTION

In many commercial fields, the service or goods providers for a particular sector present a fragmented array of individual providers where individual customers may not have an organized approach to obtaining the best services or goods at an acceptable price. Many of the resources available to search the service providers offer minimal information on the profile of the service providers. Often the only differentiating information that an individual customer obtains is the price or cost of the services. In fact, there are a number of relevant credentials, performance metrics, certifications, licenses and other objective differentiators beyond price, but previously extent systems and processes have lacked the capability to effectively represent these differentiators to automotive glass customers, whether individual customers or institutional customers such as insurance or fleet companies.

The service and part providers industry is undergoing a number of changes in technology, service models, and business profiles that present challenges to, and require changes in, traditional infrastructure. The changing nature of the industry calls for a new means by which industry participants can represent their service capabilities and capacity, as well as their points of differentiation in the market. This changing nature also calls for a new means by which customers and/or institutional clients such as insurance companies can access, validate credentials, and utilize qualified industry participants to meet the needs of customers or policyholders.

An example of such a field is the current automotive repair service industry. The automotive repair service industry is made up of large and small, local and national, traditional and non-traditional service providers. This diversity presents for the industry a great many challenges in terms of industry standards, uniform requirements, and validated points of differentiation. A subset of the automotive repair industry, the automotive glass repair and replacement service industry, is particularly susceptible to such characterizations.

A number of methods exist to coordinate services among a specific service sector, for example the automotive glass repair industry. Efforts have been made to improve the method of coordinating services within a given service sector, as seen in U.S. Pat. No. 6,950,801, the disclosure of which being hereby incorporated herein by reference. Even with the significant advances of utilizing such method, the method is based principally on pricing data input by the service provider versus data or information that represent differentiated service capabilities of the service provider other than price. These methods utilize traditional methods to link customers and service providers.

A traditional method to link customers with particular service providers within their local market included sourcing derived from telephone area codes and local exchanges. However, the gain of cellular and voice-over IP technology have rendered telephone number data less useful as indicators of the physical location of customers and service providers.

Traditionally, service providers worked from a single facility or facilities with fixed addresses. However, some service providers have expanded their service capacity through increased reliance on mobile service vehicles or by creating “bay-partner” relationships with providers of adjacent services. The traditional methods of coordinating services are not best equipped to consider the new, evolving service profile of the companies. As a result, some means to represent qualifications in addition to traditional brick and mortar-related qualifications would be desirable to enable the service providers with non-traditional service profiles to participate fully in programs for matching customers with appropriate service providers and in insurance claims programs.

It would be advantageous to provide a method, a system, and an apparatus for operating a registry of service providers which could be practiced over a wide variety of service applications that allow a customer or insurance company to seek access to pricing that is competitive and consistent with local market conditions as well as access to differentiating factors beyond price. It would be further advantageous to provide a method, a system, and an apparatus that provide a registry where service providers could distinguish themselves from their competitors by supplying a variety of information regarding their company profiles that can better represent their service capabilities to customers and/or insurance companies. In such a system in which differentiating data are provided by service providers themselves, it would be desirable to have means to validate such data to improve credibility and reliability of the system.

### SUMMARY

The present invention relates generally to methods, systems, and apparatus for operating a registry of service providers in a given service sector. Some embodiments of the methods, systems, and apparatus of the present invention can be effective in operating a registry of service providers in the automotive repair industry, such as the automotive glass repair industry.

Some embodiments of the present invention relate to a method for operating a registry of service providers in a given service sector. In one embodiment, a method for operating a registry of service providers in a given service sector comprises providing a plurality of service providers with input access to an electronic database to which each participating service provider supplies information; and validating the supplied information. Additional embodiments are described below in the Detailed Description.

Some embodiments of the present invention relate to a system for operating a registry of service providers in a given service sector. In one embodiment, a system comprises an electronic database accessible by a plurality of service providers, the database comprising supplied information relating to at least one of the plurality of service providers; and a validation engine for validating the supplied information. Additional embodiments are described below in the Detailed Description.

Some embodiments of the present invention relate to an apparatus for operating a registry of service providers in a given service sector. In one embodiment, an apparatus for operating a registry of service providers comprises a data storage device; and a processor connected to the data storage device, the storage device storing a program and a database of service providers, wherein the processor is operative with the program to receive service need information from a customer and supplied information from a service provider, and wherein the processor is operative with the program to validate the supplied information. Additional embodiments are described below in the Detailed Description.

These and other embodiments of the present invention are described in greater detail in the Detailed Description which follows.

### BRIEF SUMMARY OF THE FIGURES

FIG. 1 is a schematic, block diagram of an exemplary service coordination system of the invention.

FIG. 2 is a block diagram of a computer system which may be used in the practice of the invention.

FIG. 3 is flow diagram of an exemplary method of operating a registry of the present invention.

FIG. 4 is a flow diagram of an exemplary glass repair method using the invention.

### DETAILED DESCRIPTION

As used herein, the term “services” is not limited to labor only but may include parts alone, labor alone, or both parts and labor. Likewise, the term “service provider” may include a provider who supplies parts alone, labor alone, or a combination of parts and labor.

The invention relates generally to a method, a system, and an apparatus for operating a registry of service providers in a given service sector. In the following discussion, the general practice of the invention will first be discussed. Afterwards, a method, a system and an apparatus are explained with particular reference to operating a registry within the automotive glass repair and replacement industry. However, it is to be understood that this use of the invention is simply an exemplary use and should not be considered as limiting. The method, system, and apparatus of the invention can be practiced in a variety of fields, such as, but not limited to, towing services, plumbing services, medical services, parts supply services, retail or wholesale merchandise services, automotive parts services, collision repair services, automotive paint refinishing, fire repair services, home repair services, rental car services, and purchasing services, just to name a few. Additionally, the invention is not limited to use with insurance company policyholders but could be used for a variety of customers, such as but not limited to fleet companies, employees of a particular company, members of a particular organization or association, third party payors, and individual consumers.

Service providers do not operate in the same manner or under the same business model where different business profiles and strategies may be employed when compared to other service providers within the specific industry. Various objective factors or characteristics exist that can differentiate one service provider from another service provider. Traditionally, when comparing service providers, these factors have often been limited to cost and location. However, objective factors other than cost and location can often determine the level of value delivered and customer satisfaction created with the completion of the service.

By improving the method of communicating such differentiating factors and validating the existence of such factors, a service provider can distinguish itself from the competition and/or better represent its capabilities to serve the customer. An individual customer may receive service better in line with his or her expectations and in turn be more satisfied with his or her selection through an improved, validated line of communication.

As will be discussed below, improvements in the collection, dissemination, and validation of differentiating factors can be achieved, in some embodiments, by the operating of a registry of service providers in a given service sector according to the present invention.

In one embodiment, a method of operating a registry of service providers in a given service sector comprises providing a plurality of service providers in a given service sector with input access to an electronic database to which each participating service provider supplies information and validating the supplied information. In some embodiments, the supplied information comprises a datum or data.

The term “validating” or “validation” or “validated” as used herein with reference to, for example, validating supplied information, refers to a process, comprising one or more steps, for comparing a datum or data from a set of information, for example information supplied by a service provider in some embodiments of the present invention, with a corresponding datum, or corresponding data, from a known set of information. If the datum is the same, or substantially the same, depending on the relative importance of the datum, in both the supplied and the known sets, the datum is presumed valid, and therefore “validated”.

In some embodiments of the present invention, the known set of information comprises a datum or data in a database controlled or possessed by a “third party” other than a party performing the method or a service provider. Examples of such third party databases include, but are not limited to, governmental entity databases; certifying agency databases; licensing databases; utility databases; post office databases; financial services databases; telecommunication company databases; and search engine databases.

In some embodiments of the present invention, the known set of information comprises information gathered by a service coordinator operating an embodiment of the method of the present invention.

As set forth above, in some embodiments, in validating a datum within the supplied information, the datum is compared to a corresponding datum in a known set of information, and if the datum is the same in both sets, or substantially the same in both sets, the datum is validated.

By way of non-limiting examples, in some embodiments, an operator, or performer, of a method of the present invention might desire that data relating to identifying numbers, addresses, and similar data that can be more or less exactly quantified to be the same in the supplied information and the known set of information. In the same, or other embodiments, an operator of a method of the present invention might desire that more subjective or qualitative data, or even less important quantitative data, be substantially the same in the information provided and the known set of information. For example, in some embodiments, an operator of a method of the present invention may validate a labor description from a service provider that differs in wording but is substantially the same, or describes labor performed for a similar task, as data in the known set of information; or an operator of a method of the present invention may validate a five digit postal zip code when the known set of information from a post office database provides a nine digit postal zip code.

In some embodiments, the supplied information comprises the geographic area in which said participating service provider is capable of providing the service. In further embodiments, the electronic database may be supplied with cumulative population data for the geographic area. In other embodiments, the supplied geographic area has a corresponding price rate structure which can be displayed to the participating service provider. In further embodiments, the method comprises a step where the service provider may accept the pricing rate structure. In some embodiments, the method may allow the service provider to override the pricing rate structure.

In some embodiments, the supplied information may comprise the number of individuals associated with a participating service provider. The term “individual associated with the service provider” herein includes technicians, managers, mechanics, engineers, owners, practitioners, and any other like position or title. In other embodiments, the supplied information may comprise unique identifying information regarding each individual associated with the participating service provider that is available to provide services.

In further embodiments, the geographic area may be validated by comparing it to a maximum geographic area of service. The maximum geographic area of service may be determined by correlating the validated individuals and the validated mobile service vehicles to a maximum geographic area of service. In other embodiments, the supplied information may include validating unique identifying information by detecting and scanning for duplicate entries and/or patterns within the entries.

In some embodiments, the supplied information may comprise unique services that may be offered in certain geographic areas in proximity to a service center operated by a participating service provider. The unique services may not be offered in other more remote geographic areas. The offering of services in any particular geography may be modified at the discretion of the participating service provider. In other embodiments, the supplied information may comprise unique identifying information regarding the services and capabilities of the participating service provider in certain geographic areas.

In further embodiments, the services offered by a participating service provider in a specific geographic area may be utilized to associate a service provider with a customer seeking services in a particular geography. The nature and kind of services offered may be utilized by customers to choose a participating service provider that is best suited to meet their requirements.

In some embodiments, the supplied information comprises the level of third party training completed by an individual, third party certifications awarded to an individual, and/or professional licenses earned by an individual. In addition to information about the individual, the supplied information comprises third party certifications awarded to the service provider company. In further embodiments, the level of training, certifications, and/or professional licenses may be validated by confirming the completion of the training, awarding of the certification, and/or issuance of the license with a third party organization or group. A service coordinator may select third parties eligible for inclusion in the registry based upon such factors as their independence, professionalism, and value added.

In some embodiments, the service provider may supply information regarding the physical assets of the company. The physical assets may influence the capacity of the service provider to perform the appropriate services. In some embodiments, the physical assets may be mobile service vehicles. The service provider may supply unique identifying information regarding each mobile service vehicle in some embodiments. The unique identifying information may be a Vehicle Identification Number. In further embodiments, the Vehicle Identification Number may be validated by detecting and scanning for duplicate entries, patterns of characters, and/or entries inconsistent with specifications of Vehicle Identification Numbers.

In other embodiments, a method of the present invention may comprise employing the electronic database to schedule service for a plurality of customers. In further embodiments, a method of the present invention may comprise obtaining satisfaction data from at least a portion of a plurality of customers. The satisfaction data may be obtained through surveys of consumers and/or policyholders, or through other means. In yet a further embodiment, a method of the present invention may comprise correlating the satisfaction data with validated supplied information.

In yet other embodiments, the present invention comprises an apparatus for operating a registry of service providers comprising a data storage device and a processor connected to the data storage device where the storage device stores a program and a database of service providers, wherein the processor may be operative with the program to receive service need information from a customer and supplied information from a service provider, and wherein the processor is operative with the program to validate the supplied information. In further embodiments, the processor of the apparatus is further operative to schedule at least a portion of service providers in the database based on the service need information and validated supplied information. Further, the processor may be operative to receive customer satisfaction data information. In some embodiments, the processor may be operative to correlate the satisfaction data information with the supplied information from the service provider.

In yet further embodiments, the present invention comprises system for operating a registry of service providers comprising an electronic database accessible by a plurality of service providers, the database comprising supplied information relating to at least one of the plurality of service provides, and a validation engine for validating the supplied information.

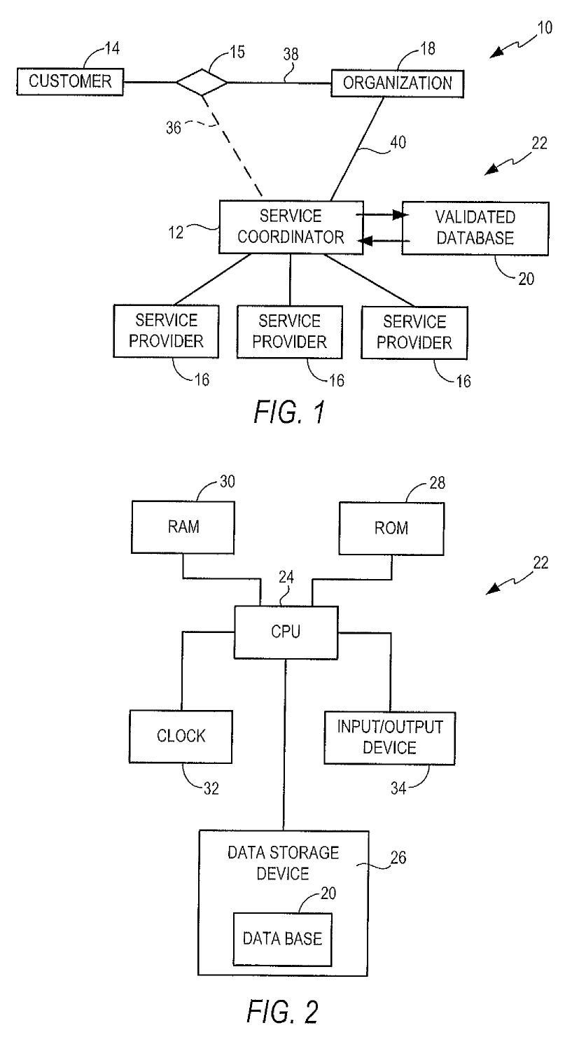

An exemplary service coordinating system 10 incorporating features of the invention is schematically shown in FIG. 1.

In the general practice of the invention, a service coordinator 12 coordinates the particular services required by a customer 14 from one of a number of service providers 16. The customer 14 may be a member of a particular company or organization 18 having a working relationship with the service coordinator 12. Alternatively, the customer 14 may be an individual consumer. The service coordinator 12 forms and maintains a validated database 20 including service providers 16 willing to perform services for the particular customer 14 and/or organization 18 under a particular pricing structure or selection criteria. The validated database 20 can be maintained, for example, on a computer system 22. Upon receipt of service need information concerning the customer 14, the service coordinator 12 may present one or more selected service providers 16 from the validated database 20 to the customer 14 for choice to conduct the desired services as described below. The service need information may be received directly from the customer 14 or through the organization 18.

The validated database 20 may be an electronic database maintained on a conventional computer system having a conventional memory device and conventional input and output devices. Alternatively, the database could also be maintained in other manners, such as manually with a writing in one or more notebooks. Of course, the manual method has several disadvantages, such as being more labor intensive, more time consuming, slower, more cumbersome, and requiring more space to the store the database (notebooks).

A block diagram of a conventional computer system 22, which may be used for the practice of the invention, is shown schematically in FIG. 2. The computer system 22 includes a central processing unit (CPU) 24 in electronic communication with a data storage device 26, such as a hard drive, optical disk, and the like for storing the database 20. The CPU 24 may also preferably be in electronic communication with one or more of a read only memory (ROM) 28 which stores CPU program instructions, a random access memory (RAM) 30 for temporary data storage, and a clock 32 for providing time signals to the CPU 24. An input/output device 34 may be connected to the CPU 24 and may be of any conventional type, such as a monitor and keyboard, mouse, touchscreen, printer, voice activated, etc. The input/output device 34 may be connected locally, remotely over a network connection to a server, database, or computer. The computer system 22 runs appropriate custom-designed or conventional software to perform the steps of the invention, for example “Ingres” software commercially available from Ingres Corporation, Redwood City, Calif. The specific hardware, firmware and/or software utilized in the system 22 need not be of a specific type but may be any such conventionally available items designed to perform the method or functions of the present invention. The computer system 22 is simply an example of one suitable computer system for the practice of the invention.

Information is conventionally gathered by a service coordinator to form and maintain the database. Traditionally, the information that is gathered by the service coordinator is limited to pricing information and/or service zones. For example, but not to be considered limiting, these traditional concepts will now be particularly described with specific reference to exemplary automotive glass repair process. Service pricing information, e.g. glass repair price information, is obtained and/or generated by the service coordinator. One exemplary resource, Mitchell International, Inc., through its subsidiary NAGS, publishes a listing of suggested glass and associated parts list prices as well as the suggested number of labor hours associated with the removal and replacement of such parts. These suggested glass and associated parts list prices and suggested labor times for each part can be used to establish a “first price” for a particular type of glass repair. This list is licensed and is publicly available for a fee. The NAGS price information for different repairs may be input into the database and stored on the data storage device as the first price for the glass repairs. Alternatively, a first price for repairs can be developed by the service coordinator or by the insurance company in any desired manner, e.g., based on historical information such as prior repair costs, dealer list prices, or in any other suitable manner.

The service zones are defined for instance geographically, demographically, by population centers, by location of the service providers, by delivery areas, by business considerations (such as geographic proximity of service providers) or in any other convenient manner. In the exemplary glass repair process under discussion, a geographic location designation for each repair shop is obtained. For example, the United States government generates and publishes a list of metropolitan statistical areas for geographical regions of the United States. The metropolitan statistical areas are typically divided or separated by population densities. The metropolitan statistical areas may be obtained and may be input into the database. Alternatively, the service zones may be defined in any convenient manner, such as by the service coordinator or the insurance company, as desired.

These factors, while helpful, are of a general nature applicable to all providers within the industry and do not allow an individual service provider to distinguish itself. In the traditional systems, a service provider often may not have the opportunity to select the area in which it provides services. In some embodiments of the present invention, a service provider can have the opportunity to differentiate itself by supplying an electronic database with additional information. In further embodiments of the present invention, the additional information supplied to the database can be validated to ensure accuracy of such information.

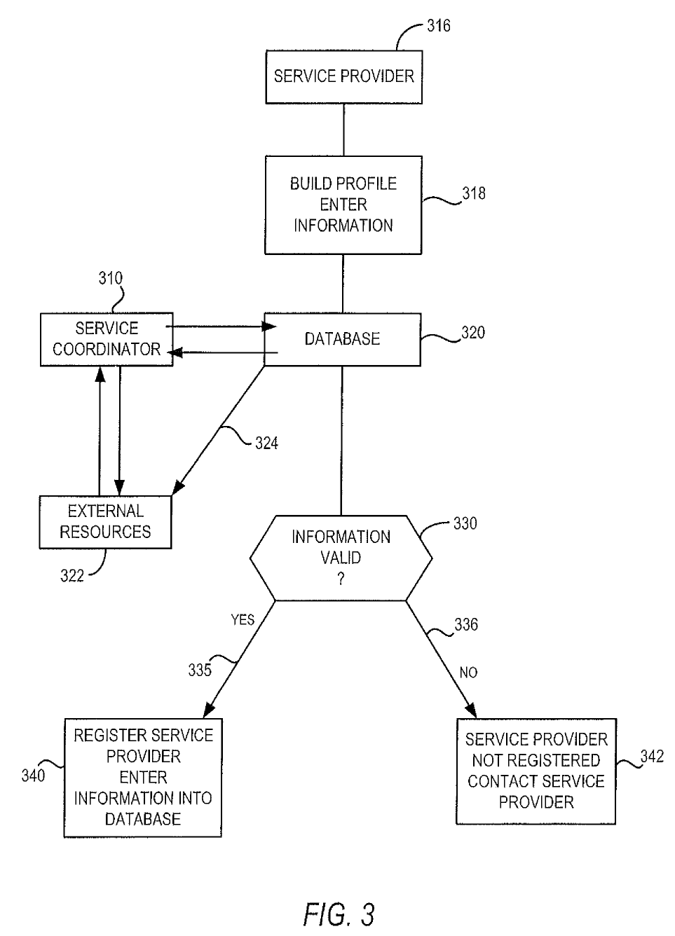

An exemplary embodiment of the present invention will now be particularly described with specific reference to the exemplary process as seen in FIG. 3. The database 320 may have multiple sources of information. In step 318, the service provider 316 builds its profile by supplying information about its company to the database. The type of information that may be supplied is discussed below. In addition, the database 320 can obtain data such from external resources 322 (step 324). For example, but not to be consider limiting, these external resources may be a government registry that supplies cumulative population data, a third party industry association that maintains a roster of certified organizations, a licensing body, or a like resource. Such external resources may be available for a fee or at no cost. The database 320 may be further in communication with a service coordinator 310 who may generate or obtain information that is input into the database 320. In step 330, the database 320 takes the supplied information from the service provider (from step 318) and compares this supplied information with the information provided by the external resources 322 and the service coordinator 310. With this comparison performed in the step 330, the supplied information may then be validated or not validated. Upon the validation of the supplied information (step 335), the service provider may be registered in the database (340), and the information can be available within the database. If the supplied information fails the validation step (step 336) for any number of reasons, the service provider may not be registered in the database (342), and service provider may be notified of the failure.

Some embodiments of the present invention can provide that a participating service provider may input information. Within a given service sector, a plurality of service providers may be provided input access to supply information regarding their company. In some embodiments, the method enables each participating service provider to supply information regarding the service provider's company profile. The service provider may supply its hours of operation, address of operation, telephone number, and emergency contact information. In further embodiments, the service provider can supply a list of services offered. In some embodiments, the list of services provided may include in-store services and/or mobile services. The term “mobile services” herein refers to services where the service provider travels to the point that is remote from its center of operation to perform the services, e.g., the location of the customer's home. For some companies, which operate in various markets under one or more brand names, the company may be able to register all the service centers and brands from a single point of access with a single representative.

In yet further embodiments, the service provider can supply the location of where services may be provided. The service provider may supply the number of locations in which it has physical facilities. The service provider may provide the number of mobile service vehicles that provide the desired services. The term “mobile service vehicle” herein refers to vans, trucks, SUVs, cars, or the like vehicle that travel to locations of service that are remote from the physical facility of the company or travel from location to location of service where no central physical facility of a company exists.

In other embodiments, the service provider can supply the service area in which it provides the desired services. In some embodiments, the service provider may supply the service area by inputting a postal code or postal codes in which it provides the services. In other embodiments, the service provider may supply the service area by inputting parameters based upon a defined mileage from particular location. In yet other embodiments, the service provider may supply the service area by referencing publicly defined boundaries, e.g., city limit lines, county lines, state lines, or any other defined boundary.

In some embodiments, the geographic area has a corresponding pricing rate structure. The pricing rate structure for a particular geographic area can change to account for business conditions, such as scarcity of parts, increased parts costs, inflation, etc. The pricing rate structure may include positive adjustments or reduction adjustments to a standard first price. The pricing rate structure can be modified by the service coordinator or an institutional customer of the service coordinator such as a fleet manager or insurance company. In some embodiments, the pricing rate structure may be displayed to the participating service provider upon entry of the geographic area of service. In some embodiments, the pricing rate structure may be accepted electronically upon the entry of the information. In other embodiments, the participating service provider may override the pricing rate structure.

In some embodiments, the electronic database can obtain cumulative population data for the geographic area supplied by the service provider. For example, the United States government generates and publishes a list of metropolitan statistical areas for geographical regions of the United States. The metropolitan statistical areas are typically divided or separated by population densities. The metropolitan statistical areas may be obtained and may be input into the database, automatically or manually. Alternatively, the population data may be input in any convenient manner, such as by a service coordinator, as desired.

In other embodiments, the service provider may supply the information regarding liability insurance. The service provider may supply level of liability insurance under which it is covered. Also, the service provider may provide the policy number of its policy. The service provider may also supply the period of coverage for the policy. Insurance carriers may have minimum requirements for the level of liability insurance coverage a service provider must carry before the insurance carrier can assign the service provider to perform the needed service.

Further, in some embodiments, the service provider can supply information regarding its physical assets. The physical assets may include, but are not limited to, the number of mobile service vehicles, the type and number of specialized equipment, and other like assets.

In further embodiments, the service provider may supply unique identifying information associated with each mobile service vehicle. In some embodiments, this unique identifying information for each mobile service vehicle may be the Vehicle Identification Number (VIN number). A VIN number refers to an identifying code specific for one vehicle. Because each mobile service vehicle will have a unique VIN, the electronic database can detect the reporting of duplications of vehicles.

In yet other embodiments, the service provider may be permitted to provide certifications that it may have received from third party industrial organizations. These may include industry-recognized training and certification, at the company level and/or individual technician level. It is desirable for a system to allow service providers to promote and be recognized for having earned such industry-recognized training and certification. It is further desirable to include these factors in a registry that may be used to determine which service provider will be selected to perform the service.

In one example of some embodiments in the automotive glass repair service industry, a participating service provider may supply that it is certified by the Auto Glass Replacement Safety Standards Council (“AGRSS™”). AGRSS™ is an accredited American National Standards Institute (ANSI) standards development organization that is dedicated to the safe replacement of auto glass. AGRSS™ has developed the AGRSS™ standard that addresses procedures, education, and product performance.

In other embodiments, the method enables a service provider to enter information regarding each individual associated the service provider. In some embodiments, the service provider can supply the number of individuals associated with the service provider. The supplied number of individuals associated with the service provider can serve as a factor that is used to calculate the service capacity of each service provider.

Also, in some embodiments the method enables a service provider to supply identifying information of each individual associated with the service provider. The service provider may provide the first and last names of each individual associated with the service provider. In further embodiments, the service provider may provide the full names of each individual associated with the service provider. In further embodiments, the service provider can supply for each individual associated with the service provider a unique identifying number. The unique identifying number may be generated by the individual, a governmental body, social organizational body, or other like body. Some examples of the unique identifying numbers can include, but not to be considered limiting, a United States Social Security Number, a Canadian Social Insurance Number, a tax identification number, or other like identifying number personal to the individual. In some embodiments, the service provider can supply for each individual associated with the service provider a partial representative selection of the unique identifying number. In further embodiments, the service provider may input an identification number of each individual issued by a third party industry association.

In some embodiments of the present invention, the method enables a participating service provider the opportunity to input professional certifications and training that each individual has earned or completed. For example, for each individual, the service provider may supply for example the individual's adhesive training system/certification completion, National Glass Association (NGA) or other industry certification earned, or state licensing held.

In some embodiments, certifications may be awarded by various industry associations and/or groups that have created valid standards for certifications. These industry associations may be globally recognized, nationally recognized, and/or locally recognized. In some embodiments of the present invention, the service provider may supply information regarding certifications that each individual associated with the service provider has earned.

In other embodiments, professional licenses may be awarded by various industry associations or groups that have created valid standards for earning a license. These industry associations or groups may be globally recognized, nationally recognized, and/or locally recognized. In some embodiments of the present invention, the service provider may supply information regarding professional licenses that each individual associated with the service provider has earned.

In other embodiments, different forms of training may be offered by various industry associations or groups that have created standard programs to train individuals within a specific industry. These industry associations or groups may be globally recognized, nationally recognized, and/or locally recognized. The forms of training may comprise, continuing education programs, seminars, hands on practical training sessions, web-based virtual programs, and any like forms. In some embodiments of the present invention, the service provider may supply information regarding different forms of training that each individual associated with the service provider has completed.

In yet other embodiments, the experience levels may be recognized by various industry associations or groups that have created a system of recording the level of experience of individuals within the industry. These industry associations or groups may be globally recognized, nationally recognized, and/or locally recognized. The experience levels that may be recognized by the various industry associations or groups may include the number of years the individual has been performing the service, the number of hours spent performing services, the level of mastery of the service, and/or any like measurement of experience level. In some embodiments of the present invention, the service provider may supply information regarding the experience levels that each individual associated with the service provider has earned.

In embodiments, the present invention comprises validating the supplied information provided by participating service providers. Validation can include determining the correctness of the supplied information by applying procedures and resources to establish acceptance. Validation can comprise comparing the supplied information with available resources to ensure the accuracy of the supplied information. Validation in accordance with the present invention can include detection of duplicate entries, detection of false entries, detection of errors, and/or the detection of omissions. The procedures of validation can comprise having the service coordinator objectively validating the supplied information by utilizing various resources. The resources can include information available within the database. The information available within the database may include information from third parties, information from the service coordinator, and/or information from the service provider. In some embodiments, the service coordinator may enter a command into the electronic database to check the correctness of the supplied information by comparing it with information available in the database. In other embodiments, the supplied information may be automatically validated by computer programs designed to compare the supplied information with the information available in the electronic database. To validate the supplied information, the specific datum of the supplied information is compared to a corresponding datum provided from a known set within the database. If the datum is the same, or substantially the same, depending on the relative importance of the datum, in both the supplied and the known sets, the datum is presumed valid, and therefore validated. In some embodiments of the present invention, the known set of information comprises information gathered by the service coordinator and information obtained from a third party.

In some embodiments, the supplied information may be validated by comparing the supplied information from the participating service providers with available resources compiled by third parties. In some embodiments, the supplied information may be validated by comparing the supplied information from the participating service providers with the information supplied by the plurality of participating service providers as is described in the following paragraphs. In other embodiments, the supplied information may be validated by comparing the supplied information within the information from the participating service provider as is described in the following paragraphs.

In some embodiments, the identifying information regarding the individuals associated with the participating service providers may be reviewed to detect duplication. In other embodiments, validating the supplied information comprises a review that an individual is not duplicated within the registry. In some embodiments, the validation can be performed through a search of the individual's full name. In some embodiments, the validation can be performed through a search of the individual's unique identifying number. In other embodiments, the validation can be performed through a search of a partial representative selection of the unique identifying number, such as, but not to be considered limiting the individual's last four digits of his or her U.S. Social Security Number or Canadian Social Insurance Number. In yet other embodiments, the validation may be performed through a search of a individual's industry association identification number. In further embodiments, the validation can be conducted using a combination of any or all of the identifying information that has been supplied to detect duplications or inconsistencies.

In some embodiments, the identifying information regarding the individuals associated with the participating service providers may be reviewed to detect patterns in the supplied information. In other embodiments, the identifying information regarding the individuals associated with the participating service providers may be reviewed to detect similarities in the supplied information. In some embodiments, validating the supplied information comprises a review that an entry is not too similar to other supplied entries. For example, validating the supplied information may comprise reviewing for combinations and/or abbreviations of the same name.

In additional embodiments, the information supplied about individual certifications, licenses, training, or experience levels can be validated. In some embodiments, the supplied certification information may be validated by obtaining confirmation from the third party industry association or group that the certification was in fact issued. In some embodiments, the validation may occur automatically. In some embodiments, the database may obtain the information from third party industry associations or groups automatically. The database may obtain the information electronically over a network connection with a server, database, computer, or like component or a local storage medium such as a hard drive. In some embodiments, the service coordinator may input into the database a list of individuals awarded certifications as provided by information supplied by the certifying third party association or group. In some embodiments, the automatic validation may be audited manually by the service coordinator. The audit may include the service coordinator manually contacting the third party industry association or group that issued the certification for confirmation that a certification was issued to the individual as specified by the participating service provider.

Similarly, in other embodiments, the supplied license information may be validated by obtaining confirmation from the third party association or group by whom the license was granted. In some embodiments, the validation may occur automatically. In some embodiments, the database may obtain the information from third party industry associations or groups automatically. The database may obtain the information electronically over a network connection with a server, database, computer, or like component or a local storage medium such as a hard drive. In some embodiments, the service coordinator may input into the database a list of individuals issued licenses as provided by information supplied by the licensing third party association or group. In some embodiments, the automatic validation may be audited manually by the service coordinator. The audit may include the service coordinator manually contacting the third party industry association or group that issued the license for confirmation that a license was issued to the individual as specified by the participating service provider.

In yet other embodiments, the level of training information may be validated by obtaining confirmation from the third party association or group that conducted the training. In some embodiments, the validation may occur automatically. In some embodiments, the database may obtain the information from third party industry associations or groups automatically. The database may obtain the information electronically over a network connection with a server, database, computer, or like component or a local storage medium such as a hard drive. In some embodiments, the service coordinator may input into the database a list of individuals that completed the training as provided by information supplied by the training third party association or group. In some embodiments, the automatic validation may be audited manually by the service coordinator. The audit may include the service coordinator manually contacting the third party industry association or group that conducted the training for confirmation that the training was completed by the individual as specified by the participating service provider.

Additionally, in other embodiments, the levels of experience information may be validated by obtaining confirmation from the third party association or group that recognizes the experience levels. In some embodiments, the validation may occur automatically. In some embodiments, the database may obtain the information from third party industry associations or groups automatically. The database may obtain the information electronically over a network connection with a server, database, computer, or like component or a local storage medium such as a hard drive. In some embodiments, the service coordinator may input into the database a list of individuals with levels of experiences that are recognized by a third party association or group as provided by information supplied by the recognizing third party association or group. In some embodiments, the automatic validation may be audited manually by the service coordinator. The audit may include the service coordinator manually contacting the third party industry association or group for confirmation.

In additional embodiments, the information supplied regarding the certifications of the service provider can be validated. In some embodiments of the present invention, the supplied certification information may be validated by obtaining confirmation from the third party industry association or group that the certification was in fact issued. In some embodiments, the validation may occur automatically. In some embodiments, the database may obtain the information from third party industry associations or groups automatically. The database may obtain the information electronically over a network connection with a server, database, computer, or like component or a local storage medium such as a hard drive. In some embodiments, the service coordinator may input into the database a list of service providers awarded certifications as provided by information supplied by the certifying third party association or group. In some embodiments, the automatic validation may be audited manually by the service coordinator. The audit may include the service coordinator manually contacting the third party industry association or group that issued the certification for confirmation that a certification was issued to the participating service provider.

As an example discussed earlier, in some embodiments of the automotive glass repair service industry, but not to be considered limiting, a participating service provider may supply that it is certified by the Auto Glass Replacement Safety Standards Council (“AGRSS™”). In an embodiment of the present invention, if a participating service provider supplies that it is AGRSS™ certified, the service coordinator may validate the supplied service provider's information with the information supplied to the AGRSS™ standards committee.

In some embodiments, the supplied information may be validated by searching the unique identifying information of a mobile service vehicle to detect duplication. In some embodiments, the unique identifying information comprises a Vehicle Identification Number (VIN number). In some embodiments, the electronic database can detect fraudulent VIN numbers by cross checking with external resources that maintain a VIN number registry. In other embodiments, the VIN numbers may be validated by reviewing public records such as property tax information as provided by governmental bodies. In further embodiments, VIN number information may be validated by checking for duplicate entries of the same VIN number. In yet further embodiments, the supplied information may be validated by detecting the non existence of patterns of the same characters within multiple VIN numbers. Too similar of patterns or repeating characters may be the result of fraudulent entries of VIN numbers to represent a greater capacity of service than actually available. In other embodiments, the supplied information may be validated by ensuring the correct number of characters are present in each VIN number entry and/or the correct type of characters are present in each position of the VIN number.

Each individual associated with a participating service provider that is supplied by the participating service provider can provide services over a defined amount of area. Similarly, each mobile service vehicle that is supplied by the participating service provider can provide services over a defined amount of area. As the number of individuals or mobile service vehicles increase, the size of the service area that can be covered may increase. The number of validated individuals and the number of validated mobile of service vehicles may be factors in the actual service capability of each provider.

In some embodiments, the number of individuals associated with the participating service provider may be correlated into a maximum geographic area of service. The number of individuals can be used as a factor in a formula or an algorithm that determines a maximum area that the service provider is capable of servicing. In other embodiments, the number of mobile service vehicles may be correlated into a maximum geographic area of service. The number of mobile service vehicles can be used as a factor in a formula or an algorithm that determines a maximum area that the service provider is capable of servicing. In some embodiments, the number of individuals and mobile service vehicles, among other factors, can be used to determine the maximum service area. Other factors to calculate the maximum service area may include cumulative population data of the area of service; population density of the area of service; infrastructure of the area of service, such as highways, roads, and bridges; geographic terrain; and other like factors.

In further embodiments, the maximum service area may be compared to a geographic area supplied by the service provider. Some embodiments of the present invention can validate that the supplied geographic area accurately represents the service capabilities of the participating service provider by comparing the supplied geographic area to a maximum service area. If the supplied geographical area differs too greatly from the maximum service area, the supplied information may not be validated, and the service provider may be accordingly notified of the discrepancy. The service provider may be notified automatically through electronic notifications and/or notified by the service coordinator who maintains the database.

Upon the validation of the supplied information, the service provider may be entered into the registry in some embodiments. Service providers whose supplied information that is not validated may not be entered into the registry. The non-entered service provider may be notified of the non-entry. In some embodiments, the notification may be automatic. In some embodiments, the notification may be through electronic communication. In other embodiments, the service coordinator may notify the service provider that it was not entered into the registry.

In some embodiments, the validation engine may validate the supplied information. The validation engine refers herein to a software routine designed to perform the validating steps discussed in the above description. The validation engine software may be custom developed for a particular system and/or may be obtained from commercially available products. When performing its function, the validation engine may utilize information from a plurality of sources. In some embodiments, the validation engine can utilize the supplied information to perform the validation step. In other embodiments, the validation can utilize information supplied by third party resources to validate the supplied information. In yet other embodiments, the validation engine can utilize information supplied by a service coordinator to validate the supplied information. In some embodiments, the validation engine may utilize a combination of any or all of the information available within the system.

In other embodiments of the present invention, the method of operating a registry of service providers comprises employing the electronic database to schedule service for a plurality of customers at the participating service providers.

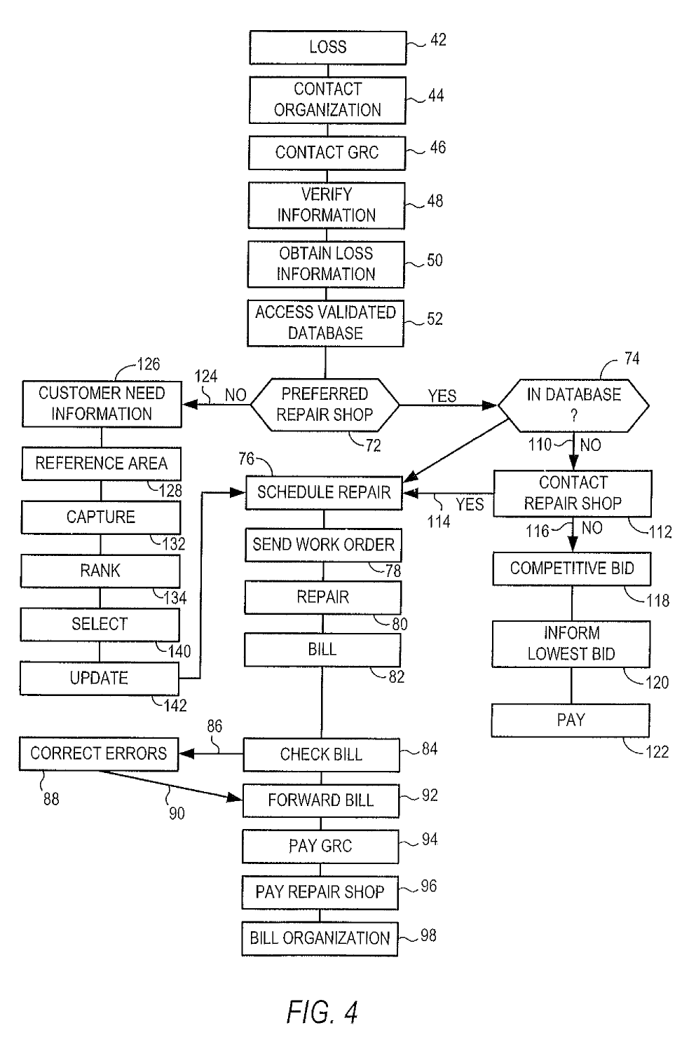

In the exemplary automotive glass repair process under discussion, with reference to FIG. 4 as needed, when the insured of the insurance company suffers an automotive glass loss (step 42), such as damage to a windshield, sidelight, backlight, etc., the insured contacts (step 44) the insurance company either directly or through a designated agent, such as the insured's local agent or a claims adjuster. This contact may be conducted, for example, telephonically, in person, via the Internet, or by any other conventional manner.

The insurance company and insured may together contact (step 46) the glass repair coordinator (GRC) or, as discussed above, the insured may contact the GRC directly, e.g., telephonically. In either case, upon initial contact, the GRC verifies (step 48) the insured's authority to request the services, e.g., that the insured has an up-to-date policy with the insurance company, such as by accessing the insurance company's computer system. The computer system of the GRC preferably has network connection with the insurance company's customer database to allow the GRC to access certain data fields within the insurance or fleet company's records to verify this information.

Assuming the insured has a valid insurance policy with the insurance company, the GRC obtains service need information, in this non-limiting example, glass loss information (step 50), from the insured such as the make and model of the vehicle, type of damage, date of damage, cause of damage, whether the vehicle is mobile, the insured's telephone number, address, current location, etc. With enough such information, the GRC accesses (step 52) the validated database maintained by the GRC via the GRC's computer system to coordinate the repair process of the insured's glass damage.

When the insured contacts the GRC, the GRC inquires if the insured has a preferred glass repair shop (step 72) where the insured wishes the glass repair services to be conducted. If the insured has a preferred repair shop, the GRC checks the validated database to see if the preferred shop is one of the shops in the validated database (step 74). If it is, the GRC contacts that repair shop to schedule the automotive glass repair (step 76) and, if the preferred repair shop can perform the repair services in a timely manner, informs the insured of the scheduled repair date. The GRC may send (step 78) the repair shop a work order, and the repair shop conducts (step 80) the glass repair.

If the insured has no preferred repair shop or if the preferred repair shop cannot conduct the repair service (step 124), the GRC obtains (step 126) customer need information from the insured, such as a postal code (home and/or work), address, whether the vehicle is mobile, etc. The validated database and/or GRC then defines, e.g., a listing of service providers having included the postal code in their service area. In other exemplary embodiments, if the vehicle is not mobile, the reference area may be plotted around the location of the vehicle factoring in the number of mobile service vehicles that the service provider has supplied. The GRC identifies or “captures” (step 132) the repair shops in the database within the reference area or repair shops that have mobile service capability to the reference area which meet the criteria for that customer's needs, i.e., those repair shops capable of conducting the repair and willing to work for the particular organization or customer involved at an established price for the service zone involved. The identified repair shops within the customer's needs are then ranked (step 134). The repair shops may be ranked in any manner designated by the particular insurance company, customer, or service coordinator, e.g., by order of total discount provided, by satisfaction index, by location, by certifications awarded, by mobile service vehicles available, by the chronological date of the last repair service awarded to the repair shop by the GRC when an insured had no repair shop preference (“service date”), or any other like manner. In some cases, ranking may be based upon a plurality of these attributes, with customized weighting factors applied to the plurality of attributes.

After ranking, the GRC may start at the top of the list and may ask the insured whether he or she will consent to have the repair work done at the first repair shop listed. Alternatively, the insured may have given advanced authorization for service providers that meet particular criteria. In this case, GRC may select the repair shop under the preauthorization.

In other embodiments of the present invention, the method of operating a registry of service providers comprises obtaining satisfaction data from at least a portion of a plurality of customers. In some embodiments, the satisfaction data may be obtained through customer surveys. The surveys may be completed by an insured individual and/or an insurance company or organization. The surveys may be conducted electronically through email or a survey posted on a website. In some embodiments, the survey may be conducted through hand-written forms. In further embodiments, the survey may be conducted through telephonic interviews.

In other embodiments, obtaining satisfaction data comprises recording customer service phone calls. The satisfaction data that may be obtained from customer service phone calls can include the frequency of calls concerning each service provider, the timing of calls concerning each service provider, the nature of calls concerning each service provider, and/or the like information about the calls. In some embodiments, the information compiled from a phone call can be entered into the electronic database for the respective participating service provider. In further embodiments, the information can be included as a factor in the ranking of the service provider during the scheduling of repair shops. In other embodiments of the present invention, the method of operating a registry of service providers comprises correlating satisfaction data with validated supplied information.

In some embodiments, the satisfaction data may be analyzed to determine critical items of the supplied information. The analysis may reveal an attribute, a specific item, and/or categories of items of the supplied information that result in the highest customer satisfaction. The results of the analysis can be incorporated into the ranking of service providers. In some embodiments, the satisfaction data may result in certain input data attributes being weighted greater than other input data attributes in customized ranking step 134. Similarly, in some embodiments, certain input data attributes may be given a weight of less than other input data attributes after the analysis of the satisfaction data. This reducing of the weight of a factor may be a result of the customer finding the attribute less important to his or her overall satisfaction. In yet further embodiments, the correlation of satisfaction data with validated supplied information may be provided to third party associations or groups that issue certifications, licenses, and/or training. The correlation information may be used as feedback for the third party associations or groups to verify the validity of their training and recognition programs.

In further embodiments, the present invention may comprise an apparatus for operating a registry of service providers comprising a data storage device and a processor connected to the data storage device where the storage device stores a program and a database of service providers, wherein the processor may be operative with the program to receive service need information from a customer and supplied information from a service provider, and wherein the processor is operative with the program to validate the supplied information. In other embodiments, the processor is operative to receive information used to validate the supplied information from third party associations or groups. In some embodiments, the processor of the apparatus is further operative to schedule at least a portion of service providers in the database based on the service need information and validated supplied information. Further, the processor may be operative to receive customer satisfaction data information. In some embodiments, the processor may be operative to correlate the satisfaction data information with the supplied information from the service provider.

In other embodiments, the present invention may comprise a system for operating a registry of service providers in a given service sector comprising an electronic database accessible by a plurality of service providers, the database comprising supplied information relating to at least one of the plurality of service providers; and a validation engine for validating the supplied information. The validation engine refers herein to a software routine designed to perform the validating steps discussed in the above description, for example, but not to be considered limiting, comparing supplied information with third party information or analyzing supplied information for duplications or patterns. The validation engine software may be custom developed for a particular system and/or may be obtained from commercially available products. When performing its function, the validation engine may utilize information from a plurality of sources. In some embodiments, the validation engine can utilize the supplied information to perform the validation step. In other embodiments, the validation can utilize information supplied by third party resources to validate the supplied information. In yet other embodiments, the validation engine can utilize information supplied by a service coordinator to validate the supplied information. In some embodiments, the validation engine may utilize a combination of any or all of the information available within the system.

In other embodiments, the system comprises a scheduling engine for scheduling service for a plurality of customers at participating service providers. The scheduling engine herein refers to a software routine designed to perform the steps discussed in the above description. The scheduling software may be custom developed for a particular system and/or may be obtained from commercially available products. In some embodiments, the scheduling engine may rank the participating service providers in an order best fitting the customer needs. In other embodiments, the scheduling engine may schedule the service according to the customer's needs.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

That which is claimed:

1. A method of operating a registry of service providers in a given service sector, comprising:
providing a plurality of service providers in the given sector with input access to an electronic database to which each participating service provider supplies information; and
validating the supplied information.

2. The method of claim 1 wherein the supplied information comprises the geographic area in which the participating service provider is capable of providing service.

3. The method of claim 2, wherein the electronic database is provided with cumulative population data for the geographic area.

4. The method of claim 2, wherein the geographic area has a corresponding pricing rate structure.

5. The method of claim 4, wherein the corresponding pricing rate structure is displayed to the participating service provider.

6. The method of claim 5, wherein the participating service provider accepts the pricing rate structure.

7. The method of claim 6, wherein the participating service provider accepts the pricing rate structure electronically.

8. The method of claim 1, wherein the supplied information comprises identifying information regarding each individual associated with the participating service provider.

9. The method of claim 8, wherein the individual associated with the participating service provider is available for providing services.

10. The method of claim 8, wherein the supplied information comprises the number of individuals associated with the participating service provider.

11. The method of claim 8, wherein the supplied information comprises unique identifying information associated with each individual associated with the participating service provider.

12. The method of claim 8, wherein the supplied information comprises the level of third party training attained by the individuals associated with the participating service provider.

13. The method of claim 8, wherein the supplied information comprises third party certifications of service performance standards awarded to individuals associated with the participating service provider.

14. The method of claim 8, wherein the supplied information comprises professional licenses of service performance standards earned by the individuals associated with the participating service provider.

15. The method of claim 1, wherein the supplied information comprises third party certifications of service performance standards awarded to the service provider.

16. The method of claim 1, wherein the supplied information comprises the physical assets of the service provider.

17. The method claim 16, wherein the physical assets influence the capacity of the service provider to provide a service.

18. The method of claim 16, wherein the physical assets comprise mobile service vehicles.

19. The method of claim 18, wherein the supplied information includes unique identifying information associated with each mobile service vehicles.

20. The method of claim 19, wherein the unique identifying information is a Vehicle Identification Number.

21. The method of claim 1, wherein the supplied information comprises services that are offered by the service provider.

22. The method of claim 21, wherein the services can be specified for at least one geographical area.

23. The method of claim 21, wherein the services are unique to a geographical area.

24. The method of claim 1, wherein the supplied information comprises data.

25. The method of claim 24, wherein the data supplied by the participating service provider is compared to a known set of data.

26. The method of claim 25, wherein when a supplied datum is the same as the corresponding datum in the known set, the supplied datum is validated.

27. The method of claim 25, wherein when a supplied datum is substantially the same as the corresponding datum in the known set, the supplied datum is validated.

28. The method of claim 2, wherein validating the supplied geographical area information comprises
validating supplied information regarding individuals associated with the participating service provider;
validating supplied information regarding mobile services vehicles;
correlating the validated supplied information regarding the individuals associated with the participating service provider and the supplied information regarding the mobile service vehicles to a maximum geographic area of service; and
validating the geographical area with the maximum geographic area of service.

29. The method of claim 11, wherein validating the unique identifying information comprises detecting duplicate entries of information.

30. The method of claim 11, wherein validating the unique identifying information comprises detecting patterns within the supplied information.

31. The method of claim 12, wherein validating the level of training comprises obtaining confirmation from a third party training organization.

32. The method of claim 13, wherein validating the third party certifications comprises obtaining confirmation from the third party.

33. The method of claim 14, wherein validating the professional licenses comprises obtaining confirmation from a licensing body that issued the professional license.

34. The method of claim 15, wherein validating the third party certifications comprises obtaining confirmation from the third party.

35. The method of claim 20, wherein validating the Vehicle Identification Number comprises detecting duplicate entries of Vehicle Identification Numbers.

36. The method of claim 20, wherein validating the Vehicle Identification Number comprises detecting patterns of characters within Vehicle Identification Numbers.

37. The method of claim 20, wherein validating the Vehicle Identification Number comprises detecting entries inconsistent with specifications of Vehicle Identification Numbers.

38. The method of claim 1, further comprising employing the electronic database to schedule service for a plurality of customers at the participating service providers.

39. The method of claim 1, further comprising obtaining satisfaction data from at least a portion of a plurality of customers.

40. The method of claim 39, wherein obtaining satisfaction data comprises customer surveys.

41. The method of claim 39, further comprising correlating the satisfaction data with validated supplied information.

42. An apparatus for operating a registry of service providers in a given service sector comprising:
a data storage device; and
a processor connected to the data storage device, the storage device storing a program and a database of service providers, wherein the processor is operative with the program to receive service need information from a customer and supplied information from a service provider, and wherein the processor is operative with the program to validate the supplied information.

43. The apparatus of claim 42, wherein the processor is further operative to schedule at least a portion of service providers in the database based on the service need information and validated supplied information.

44. The apparatus of claim 42, wherein the processor is further operative to receive customer satisfaction data information.

45. The apparatus of claim 44, wherein the processor is further operative to correlate the satisfaction data information with the supplied information from the service provider.

46. A system for operating a registry of service providers in a given service sector comprising:
an electronic database accessible by a plurality of service providers, the database comprising supplied information relating to at least one of the plurality of service providers; and
a validation engine for validating the supplied information.
